(19) United States
(12) Patent Application Publication
(10) Pub. No.: US 2012/0216623 A1
(43) Pub. Date: Aug. 30, 2012

(54) In situ roof covering test method & device

(76) Inventor: Matthew B. Phelps, Galveston, TX (US)

(21) Appl. No.: 12/931,772

(22) Filed: Feb. 10, 2011

Related U.S. Application Data
(60) Provisional application No. 61/303,535, filed on Feb. 11, 2010.

(51) Int. Cl. G01N 3/00

(52) U.S. Cl. 73/788

(57) ABSTRACT

A machine for testing shingles and structure covering with a measuring devise supported above the surface, The way it measures shingle strength, Database of new undamaged shingle strength values based upon manufacture, shingle type and approval ASTM test method, How the devise attaches to the shingle specimen, Moveable and repeatable results, and Compares damaged and non-damaged shingles based upon their ASTM test method certification.

### CROSS REFERENCE TO RELATED APPLICATIONS

The Inventor is claiming the benefit of a provisional patent application. Application No. 61/303,535, filed Feb. 11, 2010. This provisional patent is the basis for the filing of this Utility Patent.

### STATEMENT REGARDING FEDERALLY SPONSORED RESEARCH OR DEVELOPMENT

This patent has no relationship to any federally sponsored research or development.

### BACKGROUND OF THE INVENTION

This invention relates generally to the field of forensic engineering investigation and reporting and more specifically to a machine for testing shingles sealant strength and mechanical fastener. This devise can measure both sealant strength and mechanical fastener strength. Sealant and mechanical faster strength are tested separately.

Currently, shingle damage is determined by physical observation and not by a quantifiable test. Some insurance carriers do not consider wind lifted shingles to be damaged, because the damage is not readily visible and the belief that the sealant layer that seals the shingle to the shingle below will reseal and perform as before. Until now no one has tested wind lifted shingles to determine if they reseal with the same level of performance as before they were separated.

This machine and method will provide clear and documentable measured results of the amount of force required to separate the sealed exposure (end) of damaged and non damaged shingles. The subjective documentation of the damage will assist the carrier and policyholder in the assessment of the roof claim much more efficiently than the current objective method used.

All shingles sold in the US must be tested and certified by one or more ASTM test methods. The ASTM test method under which a shingle was certified will provide a documented performance reference regardless of the manufacture. The certified information will be the base line used in the test of the damage shingle, thus give more specific data as opposed to general data.

Currently no field testing technology exist.

Some related ASTM test methods and supporting documentation includes:

ASTM D1079 Terminology Relating to Roofing and Waterproofing

ASCE7-02 Minimum Design Loads for Buildings and Other Structures

Some existing test methods for new shingles include:

ASTM D7158-08d Standard Test Method for Wind Resistance of Asphalt Shingles (Uplift Force/Uplift Resistance Method) is a laboratory test method for certification of new shingles.

ASTM D7158 is not a field test method and is only used on new undamaged shingles and only simulates a 35 mph wind speed.

ASTM D225 Specification for Asphalt Shingles (Organic Felt) Surfaced With Mineral Granules

ASTM D3161 Test Method for Wind-Resistance of Asphalt Shingles (Fan-Induced Method)

ASTM D6381 Test Method for Measurement of Asphalt Shingle Mechanical Uplift Resistance ANSI/UL Standard

ANSI/UL2390-04 Test Method for Wind Resistant Asphalt Shingles with Sealed Tabs

Both insured and insurance carrier are dependent upon physical inspections and professional opinion to determine if the subject roof or wall covering is damaged. This method frequently results in a legal “tug-of-war” between the parties.

This method eliminates guess work and provides repeatable, documentable test results from the subject location and with a minimum of effort and disturbance to the subject property.

Confirmed, verifiable field test results are much preferred to a physical inspection and conflicting professional opinions.

None of the ASTM or ANSI/UL test standards and methods are intended for in situ testing of damaged shingles. All of the existing methods are laboratory procedures that are intended for new undamaged shingles.

None of the testing standards and methods account for shingle age in comparison of shingle sealant tabs. Our method not only compares field tested sealant tab separation values to undamaged shingles that were tested under similar ASTM test methods, our method will compare shingles of the same age and the same ASTM test method.

### BRIEF SUMMARY OF THE INVENTION

The primary object of the invention is to eliminate opinion based decisions regarding damage of wind lifted shingles, by providing factual, verifiable and repeatable data. The data collected will be used in a “living document” database of shingle sealant separation values of all types of shingles their age and location. The measured values of suspected damaged shingles can be compared to undamaged shingles of similar type, manufacture, age, location and ASTM test methods.

Additional benefits are:

It works on any type or manufacture of composition shingle or style of shingle.

It is portable allowing for quick set-up and take-down on almost any roof.

It is rugged and weather resistant.

The instruments used in the design are calibrated and traceable to a national standard.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for testing shingles and structure covering comprising: A measuring devise supported above the surface, The way it measures shingle strength, database of undamaged shingle strength values based upon manufacture, shingle type, age, location, and approval ASTM test method. How the devise attaches to the shingle specimen, moveable and repeatable results, and compares damaged and non-damaged shingles based upon their ASTM test method certification.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Machine for testing shingles sealant and mechanical fastener strength of structure covering comprising a measuring devise supported above surface and the way it measures shingle sealant and mechanical fastener strength.

Database of undamaged values based upon manufacture, age, type, approval ASTM test method. How the machine attaches to specimen. Moveable and with repeatable results. Compares undamaged shingle sealant and mechanical fastener strength based upon their type, manufacture, age, ASTM certification method.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Drawing 1.

FIG. 1 is a detailed view of the invention

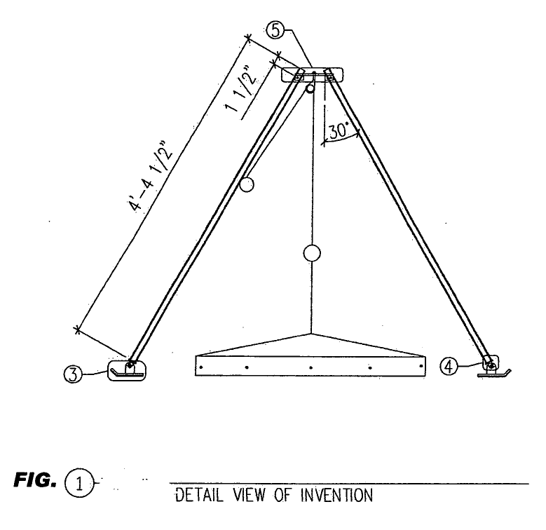

FIG. 2 is an elevation view of the invention.

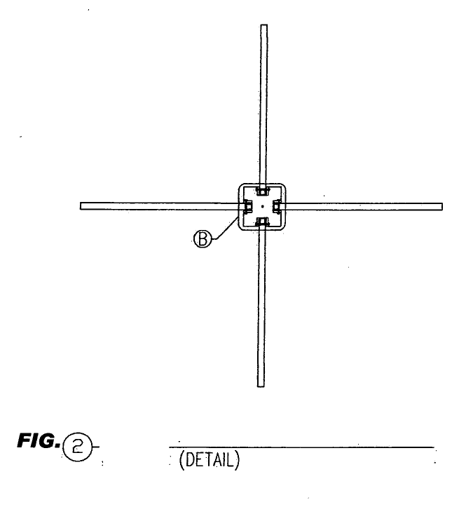

FIG. 3 is a detailed view of foot the invention.

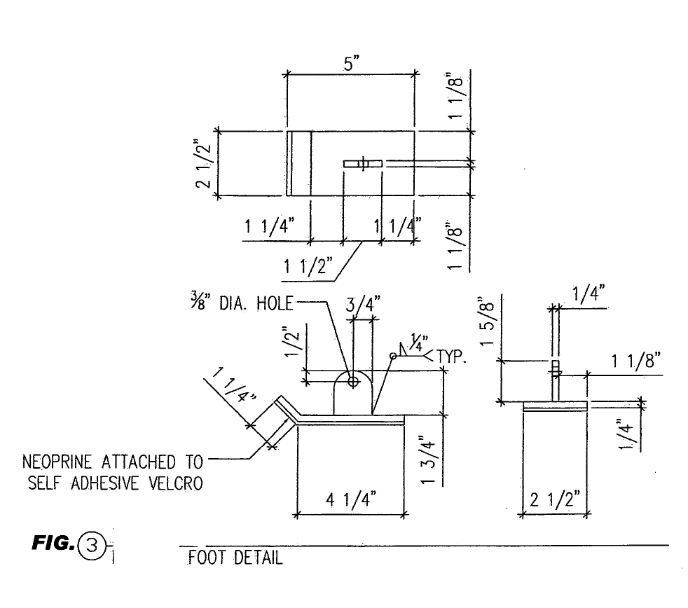

FIG. 4 is a detailed view of the bottom of the leg of the invention.

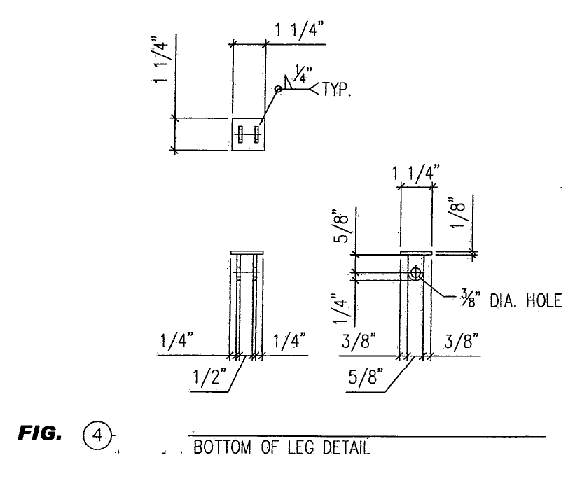

FIG. 5 is a detailed view of the top plate of the elevation

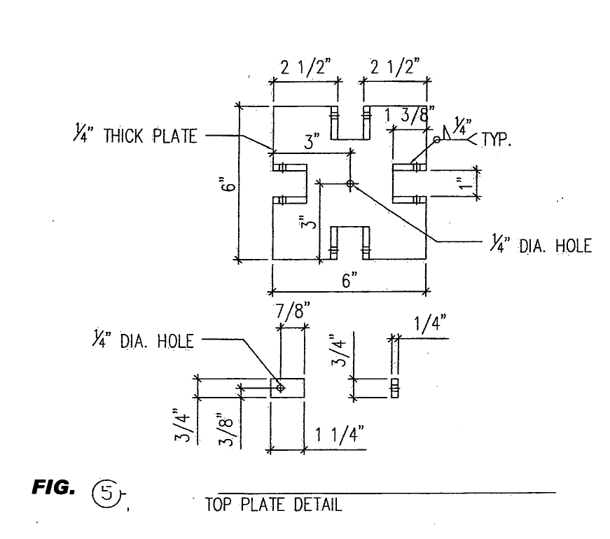

Drawing 2

Is a flow chart of how the invention is used

What is claimed is:

1. A machine for testing shingles and structure covering comprising:
A measuring devise supported above the surface;
The way it measures shingle strength;
Database of new undamaged shingle strength values based upon manufacture, shingle type and approval ASTM test method;
How the devise attaches to the shingle specimen;
Moveable and repeatable results; and
Compares damaged and non-damaged shingles based upon their ASTM test method certification.
